(19) United States
(12) Patent Application Publication
(10) Pub. No.: US 2005/0219537 A1
(43) Pub. Date: Oct. 6, 2005

(54) Metal surface inspection device

(75) Inventors: Hiroshi Tange, Fuji-shi (JP); Ushio Suzuki, Nukata-Gun (JP)

Correspondence Address: BLANK ROME LLP, 600 NEW HAMPSHIRE AVENUE, N.W., WASHINGTON, DC, 20037, US

(73) Assignees: JATCO Ltd., Fuji-shi (JP); FUJI OPTO CO., LTD., Okazaki-shi (JP)

(21) Appl. No.: 11/090,008

(22) Filed: Mar. 28, 2005

(30) Foreign Application Priority Data
Mar. 29, 2004 (JP) 2004-097234

(51) Int. Cl. G01N 21/88

(52) U.S. Cl. 356/430; 356/237.2

(57) ABSTRACT

A metal surface inspection device which does not perform excessive detection of a harmless flaw, for example, a gloss mark. This task is achieved by providing a first discrimination portion which compares a difference value and a predetermined threshold value for discriminating the presence of a defect on an inspectable surface. This discriminated result is “provisional” and a final discrimination result is obtained by the operation of a second discrimination portion. Here, among the discriminated results of the first discrimination portion, the discrimination duration time corresponding to a harmful flaw is shorter and to the contrary the discrimination duration time corresponding to a harmless flaw is longer. Consequently, the difference between a harmful flaw and a harmless flaw are distinguishable by adjusting a discrimination reference value in the second discrimination portion.

### BACKGROUND OF THE INVENTION

1. Field of the Invention

The present invention relates to a metal surface inspection device. More particularly, the present invention relates to a metal surface inspection device suitable for use in inspecting the surface of metal rings which are parts that constitute a V-belt type of a Continuously Variable Transmission belt (hereinafter denoted as “CVT belt”).

2. Description of the Related Art

Conventionally, there is a known CVT belt structure which laminates a plurality of thin metal rings in a stack of approximately 0.2 mm in thickness to which steel elements are consecutively attached.

FIG. 10 is an outline view of a CVT belt. In this diagram, a CVT belt 1 is constructed by assembling two laminated bands of a layered belt 2 that contain a stack of a number of metal rings 2a (for example, a laminated band composed of about 12 endless layers) which are supported by a layered element 3 composed of a large number of steel elements 3a (for example, about 400 elements).

In this manner, the structure of the CVT belt 1 is produced through the following processes:

(1) First, a ring-shaped drum is formed by welding together the ends of a thin sheet of ultrahigh strength steel, such as maraging steel.

(2) Next, the drum is cut into round slices of a predetermined width and rolled to create metal rings 2a of a basic peripheral length.

(3) Next, after performing a solution treatment, etc. to the above-mentioned metal rings 2a, the necessary peripheral length (namely, the peripheral difference between the inner and outer periphery) corresponding to the stacked layers of the CVT belt 1 using a “peripheral length correction device” is accomplished. Furthermore, aging treatment, nitride treatment, etc. are performed to increase the hardness of the metal rings 2a.

(4) Lastly, the metal rings 2a are laminated after undergoing the above-mentioned process (3), the steel elements 3a are consecutively attached and the CVT belt 1 is completed.

Naturally, since these metal rings 2a undergo the above-mentioned processes (such as manufacture of the drum, cutting, rolling, solution treatment, peripheral length correction, aging treatment, nitride treatment, etc.), partial defects occur, such as abrasions and indentations on the front and rear faces (front and rear end faces) of the metal rings 2a.

As an inspection method for such defects, there is a process for factory workers to determine the existence of abrasions, indentations, etc. by visually observing the front and rear faces of the metal rings 2a preceding the CVT belt manufacturing process (4), namely by directly viewing parts or using a magnifying glass. However, in this antiquated method there is the drawback of being inefficient due to the fact that human error rate is always higher than an automated process. Thus, satisfactory reproducibility and reliability are not routinely acquired.

As for conventional prior art which is applicable to the surface inspection of the above-mentioned metal rings 2a, for example, Japanese Laid-Open Patent Application No. H11-248637 (1999) titled “DEFECT DETECTING DEVICE” (hereinafter denoted as “conventional prior art device”) is known.

FIG. 11 is a conceptual line block diagram of a conventional prior art device. This conventional prior art device comprises a plurality of the light guiding paths 6a˜6c (optical fiber) for guiding irradiating light which travels unidirectionally from the inspection light source 4 to the inspectable surface 5 (the front or rear faces of the metal rings 2a). Also, at least two light guiding paths 8a and 8b (optical fiber) are arranged alternately in between the light guiding paths 6a˜6c for guiding the reflected light Pa and Pb from the inspectable surface 5 to the light reception segments 7a and 7b. Noteworthy is the spacing arrangement of the two light guiding paths 8a and 8b which are separated at a slight distance L.

In such a configuration, when an inspectable surface does not have a defect, such as a flaw, etc., the reflected light Pa and Pb guided by the two light guiding paths 8a and 8b is supplied to the light reception segments 7a and 7b at substantially the same intensity. On the other hand, when an inspectable surface 5 has a minor defect, since there is a decline (light intensity decline by diffused reflection) in the reflected light of an applicable defective part, a difference occurs in the light of the light guiding paths 8a and 8b and the existence of a defect can be automatically discriminated from the amount of this difference.

However, in the above-mentioned conventional prior art, although the above-mentioned conventional prior art is a beneficial device from the viewpoint of being able to automatically discriminate whether or not a defect exists on an inspectable surface, there is a drawback that a flaw (hereinafter denoted as a “harmful flaw”) which affects the durability of a CVT belt and a flaw (hereinafter denoted as a “harmless flaw”) which does not affect the durability of a CVT belt are undistinguishable.

Here, a classic example of a harmful flaw is tiny flaw which deeply penetrated into the inspectable surface 5. A classic example of a harmless flaw is merely a gloss mark of a relatively large size scarred on the surface of the inspectable surface 5. A harmful flaw reduces the thickness of the object to be inspected, for example the metal rings 2a, and impairs the durability of that portion. However, a harmless flaw is simply a gloss mark which does not contribute to a decline in durability.

FIG. 12 is a conceptual diagram detection of a “harmful flaw” in a conventional prior art device. In FIG. 12A, the two light guiding paths 8a and 8b are only separated by the distance L and the inspectable surface 5 is traveling unidirectionally at a speed V.

Initially, in the situation where a harmful flaw 5a exists on the inspectable surface 5, the end face of the light guiding path 8b for light reception on the far right side is opposite to the harmful flaw 5a. Also, after a brief period of time, the end face of the light guiding path 8a for light reception on the far left side is opposite to the harmful flaw 5a. Here, the harmful flaw 5a′ is the harmful flaw 5a after traveling at speed V.

The light intensity declines by the diffused reflection of the harmful flaw 5a (5a′) as the light is first received by the right light side reception segment 7b and the light is received by the left side light reception segment 7a after a brief period of time. In this instance, FIG. 12B shows the output signal waveform of the light reception segment 7b on the right side. FIG. 12C shows the output signal waveform of the light reception segment 7b on the left side.

In these signal waveforms, numbers (“50”, “0”) indicate signal levels convenient for explanation. For example, “50” is the strength of the reflected light level from a normal portion of the inspectable surface 5 and “0” is the weakness of the reflected light level from a harmful flaw 5a (5a′) portion of the inspectable surface 5.

At this stage, when the difference of these two signal waveforms is calculated, namely, [FIG. 12B waveform]—[FIG. 12C waveform], the waveform of FIG. 12D (hereinafter denoted as “difference value”) will be acquired.

As for this difference value, the result becomes “0” when the [FIG. 12B waveform] and the [FIG. 12C waveform] are both “50”. The result becomes “−50” when the [FIG. 12B waveform] is “0” and the [FIG. 12C waveform] is “50”. Further, the result becomes “50” when the [FIG. 12B waveform] is “50” and the [FIG. 12C waveform] is “0”.

Consequently, by applying a high side threshold value SL_H which is a level slightly below “50” and a low side threshold value SL_L which is a level slightly below “−50” as such difference values, a signal 9 and 9′ corresponding respectively to the harmful flaw 5a (5a′) can be isolated and a defect detection alarm can be emitted.

On the other hand, FIG. 13 is a conceptual diagram detection of a “harmless flaw” in a conventional prior art device. In FIG. 13A, a harmless flaw 5b exists on the inspectable surface 5. As this harmless flaw 5b is merely a gloss mark, it reflects more intense light than other portions (portions without a flaw) on the inspectable surface 5. In FIG. 13B shows the output signal waveform of the light reception segment 7b. FIG. 13C shows the output signal waveform of the light reception segment 7a. These signal waveforms include a high signal level portion (portion shown by the number “100” for convenience) proportionate to the intense reflected light of the harmless flaw 5b.

Thus, in a similar fashion to the above-stated “harmful flaw”, FIG. 13D shows the calculation of the “difference” of the output signal waveform of the light reception segment 7b and the output signal waveform of the light reception segment 7a. Also present in this difference value is the portion which exceeds the threshold value (SL_H, SL_L).

Specifically, the threshold values (SL_H, SL_L) are exceeded at the “a” portion result of “50” when the [FIG. 13B waveform] is “100” and the [FIG. 13C waveform] is “50”; at the “b” portion result of “60” when the [FIG. 13B waveform] is “100” and the [FIG. 13C waveform] is “40”; at the “c” portion result of “−60” when the [FIG. 13B waveform] is “40” and the [FIG. 13C waveform] is “100”; and further at the “d” portion result of “−50” when the [FIG. 13B waveform] is “50” and the [FIG. 13C waveform] is “100”.

Consequently, in a difference value such as this when the same above-mentioned threshold value “50” (a high side threshold value SL_H which is a level slightly below “50” and a low side threshold value SL_L which is a level slightly below “−50”) is applied, a harmless flaw 5b which can be ignored as having no impact on the finished product will be detected as a defect. As a result, the object (metal rings 2a) to be inspected which possesses only a harmless flaw will be eliminated as a defective part (CVT belt). This is a waste of resources and not preferred in terms of manufacturing cost.

Therefore, the object of the present invention is to provide an inspection device for metal rings which does not perform excessive detection of a harmless flaw, for example, a gloss mark.

### SUMMARY OF THE INVENTION

A metal surface inspection device related to the present invention comprises a light source for illuminating an inspectable surface of an object to be inspected; a first light guiding path for guiding a reflected light from an inspectable surface to a first light detector and a second light guiding path for guiding the reflected light to a second light detector; a difference value calculation means for calculating a difference value between an electrical signal outputted from the first light detector or an electrical signal correlated to its electrical signal and an electrical signal outputted from the second light detector or an electrical signal correlated to its electrical signal; and a first discrimination means for discriminating the presence of a defect on an inspectable surface and comparing the difference value with a predetermined threshold value; a second discrimination means for validating the discriminated result of the first discrimination means in cases where an existing defect on an inspectable surface is discriminated by the first discrimination means and only when the discrimination duration time of the same existing defect is less than a predetermined base time.

Additionally, as a preferred embodiment of the present invention, the second discrimination means includes a measuring means for measuring the time width of the portion with an existing defect in the signal outputted from the first discrimination means and a judging means for judging whether or not the time width measured by the measuring means exceeds a predetermined base time.

Furthermore, the metal surface inspection device related to the present invention comprises a light source for illuminating an inspectable surface of an object to be inspected; a first light guiding path for guiding a reflected light from an inspectable surface to a first light detector and a second light guiding path for guiding the reflected light to a second light detector; a difference value calculation means for calculating a difference value between an electrical signal outputted from the first light detector or an electrical signal correlated to its electrical signal and an electrical signal outputted from the second light detector or an electrical signal correlated to its electrical signal; a first discrimination means for discriminating the presence of a defect on an inspectable surface and comparing the difference value with a predetermined threshold value; and wherein light from the light source diagonally illuminates toward an inspectable surface.

According to the present invention, the first discrimination means compares a difference value and a predetermined threshold value for discriminating the presence of a defect on an inspectable surface. Even though the existence of a defect on an inspectable surface is discriminated, this discriminated result is “provisional” (conditional) and a final discrimination result is obtained by the operation of a second discrimination means. Specifically, “in cases where an existing defect on an inspectable surface is discriminated by the first discrimination means and only when the discrimination duration time of the same existing defect is less than a predetermined base time, the discriminated result of the first discrimination means is validated.”

Here, among the discriminated results of the first discrimination means, the discrimination duration time corresponding to a harmful flaw is shorter and to the contrary the discrimination duration time corresponding to a harmless flaw is longer. Consequently, the difference between a harmful flaw and a harmless flaw are distinguishable by adjusting a discrimination reference value (base time) in the second discrimination means.

Further, a harmful flaw and a harmless flaw are distinguishable even if the above-stated second discrimination means is excluded. It is only necessary to irradiate light from a light source diagonally toward an inspectable surface. As the reflected light intensity of a harmless flaw including a gloss mark is lower, it is also possible to avoid exceeding the threshold value of the first discrimination means.

The above and further objects and novel features of the present invention will more fully appear from the following detailed description when the same is read in conjunction with the accompanying drawings. It is to be expressly understood, however, that the drawings are for the purpose of illustration only and are not intended as a definition of the limits of the invention.

### BRIEF DESCRIPTION OF THE DRAWINGS

FIG. 1 is a conceptual line block diagram of a metal surface inspection device;

FIG. 2 is a conceptual line block diagram of an inspection section 14 in the first embodiment;

FIG. 3 is a block diagram of a judgment section 40 in the first embodiment;

FIGS. 4A˜4D are conceptual diagrams of a harmful flaw in the first embodiment;

FIGS. 5A˜5D are conceptual diagrams of a harmless flaw in the first embodiment;

FIG. 6 is a conceptual line block diagram of an inspection section 14 in the second embodiment;

FIG. 7 is a block diagram of a judgment section 40 in the second embodiment;

FIGS. 8A˜8B are drawings showing the reflection condition of an inspectable surface in the second embodiment;

FIG. 9 is a waveform diagram of a difference value Sd which includes a “harmless flaw” and a “harmful flaw” signal in the second embodiment;

FIG. 10 is an outline view of a CVT belt;

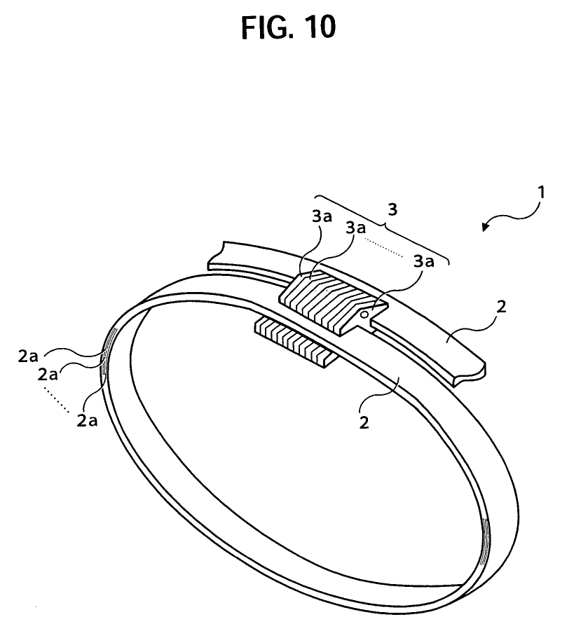

FIG. 11 is a conceptual line block diagram of a conventional prior art device;

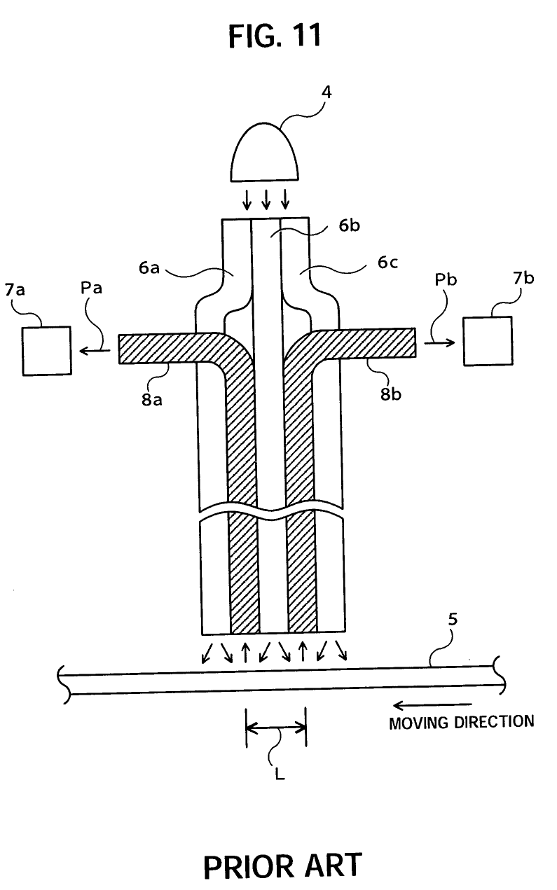

FIG. 12 is a conceptual diagram detection of a “harmful flaw” in a conventional prior art device; and

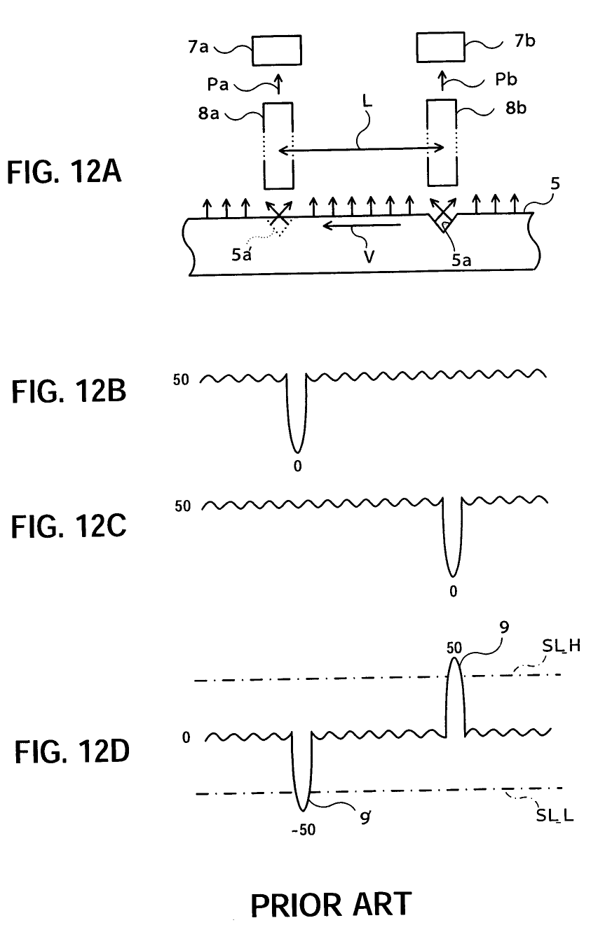

FIG. 13 is a conceptual diagram detection of a “harmless flaw” in a conventional prior art device.

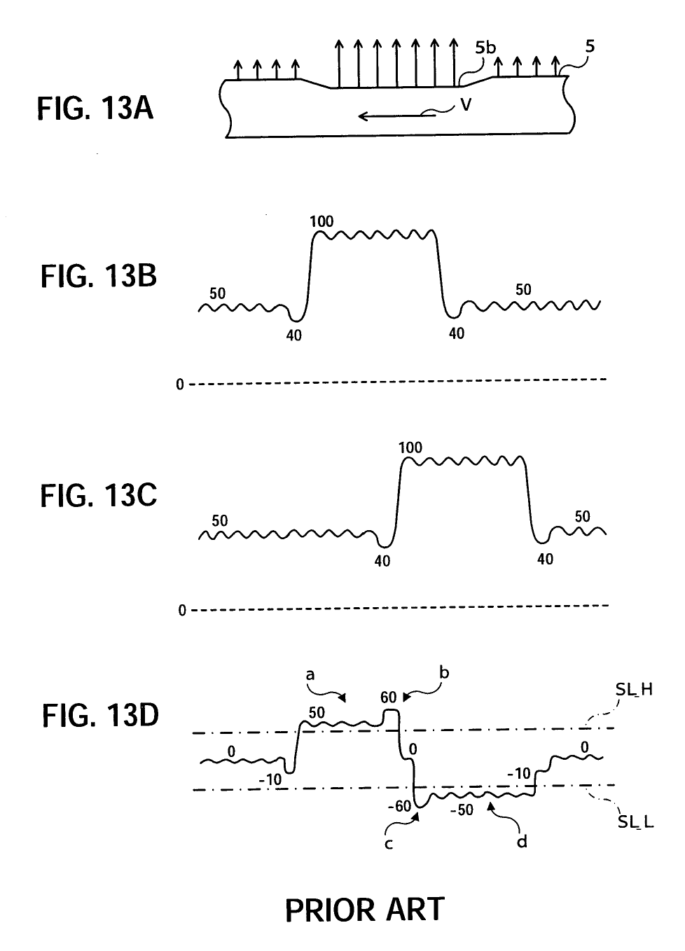

### DETAILED DESCRIPTION OF THE PREFERRED EMBODIMENTS

The preferred embodiments of the present invention will hereinafter be described in detail with reference to the drawings. Additionally, in the following explanation of specific or examples of various details, numerical values or character strings and other illustrative symbols are merely references to clarify the concept of the present invention. Accordingly, the concept of the present invention should not be limited explicitly to this terminology entirely or in part.

In addition, explanation is omitted which describes details of well-known methods, well-known procedures, well-known architecture, well-known circuit configurations, etc. (hereinafter denoted as “common knowledge”) for the purpose of concise explanation, but does not intentionally exclude this common knowledge entirely or in part. Therefore, relevant common knowledge which is already known by persons skilled in the art at the time of filing the present invention is included in the following description.

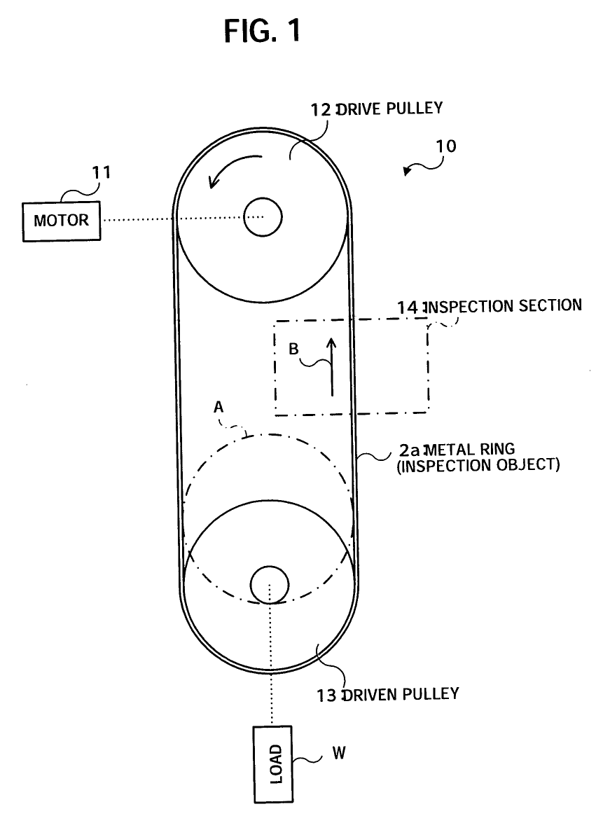

FIG. 1 is a conceptual line block diagram of a metal surface inspection device. An inspection device 10 comprises a fixed position drive pulley 12 which is rotary driven by a motor 11, a variable position driven pulley 13 which is separately situated on the same rotational plane as the drive pulley 12 and an inspection section 14.

When examining the metal rings 2a which are the object to be inspected, first, the driven pulley 13 is positioned at an initial position (refer to position “A” on the dashed dotted line). Subsequently, the metal rings 2a are wound around the two pulleys (drive pulley 12 and driven pulley 13). Next, the desired tension is applied to the metal rings 2a by supplying load W which has a predetermined mass (for example, 80 kg) and drives the driven pulley 13. In the state of operating the motor 11 which causes the metal rings 2a to rotate unidirectionally (the direction of arrow “B”) and with the inspection section 14, a front and rear face inspection is performed.

<First Embodiment>

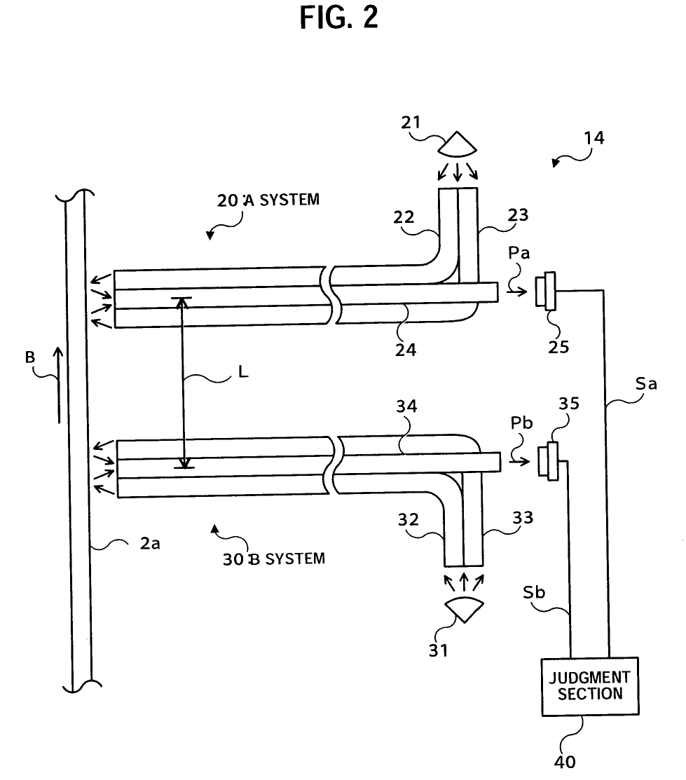

FIG. 2 is a conceptual line block diagram of an inspection section 14 in the first embodiment. Referring to this drawing, the inspection section 14 comprises at least two optical sensor sections 20 and 30 (hereinafter denoted as “A system optical inspection section 20” and “B system optical inspection section 30”, or simply “A system 20” and “B system 30”) and a judgment section 40. The reason for comprising “at least two” the optical sensor sections 20 and 30 is described later.

The A system 20 and B system 30 have the same configuration. Namely, the A system 20 (the B system 30) configuration includes two illuminating optical fibers 22 and 23 (32 and 33) for the purpose of guiding the light from a light source 2l (31) in parallel to an inspectable surface (here, although assumed as the “front face” of the metal rings 2a, it may be the “rear face”) of an object to be inspected (the metal rings 2a); a light reception optical fiber 24 (34) inserted between the illuminating optical fibers 22 and 23 (32 and 33); and a light detector 25 (35) which converts reflected light Pa (Pb) into an electrical signal Sa (Sb) from an inspectable surface guided with the light reception optical fiber 24 (34). The light reception optical fiber 24 constitutes “a first light guiding path” mentioned earlier in the summary of the present invention and a light detector 25 which constitutes “a first light detector” also mentioned in the above summary. Additionally, the light reception optical fiber 34 constitutes “a second light guiding path” and a light detector 35 constitutes “a second light detector” both mentioned in the summary of the present invention.

The judgment section 40 judges whether or not a flaw exists on an inspectable surface of the metal rings 2a based on the electrical signal Sa outputted from the light detector 25 of A system 20 and the electrical signal Sb outputted from the light detector 35 of the B system 30. The basic principle as also described in the opening patent document 1 pertains to “the intensity of the light which enters into the two light detectors 25 (35) is substantially the same when an inspectable surface does not contain a defect and differs when there is a defect”. Also, “the difference value of the electrical signals Sa and Sb outputted from the two light detectors 25 (35) is acquired. When this difference value is greater, this is indicative that an inspectable surface contains a defect and will be discriminated”.

In other words, when an inspectable surface of the metal rings 2a does not have a defect, the inspectable surface is a smooth surface and the light from the illuminating optical fibers 22 and 23 (32 and 33) is equally reflected in terms of being smooth and diffused reflection is hardly generated. Accordingly, the intensity of the light which enters into the light detectors 25 (35) is composed of the appropriate strength and substantially the same amount. In this case, the difference value of the electrical signals Sa and Sb are practically set to “0”.

On the other hand when an inspectable surface of the metal rings 2a has a defect, the light from the illuminating optical fibers 22 and 23 (32 and 33) will reflect diffusely at the defective spot. Thus, the intensity of the light guided to the light detector 25 (35) via the light reception optical fiber 24 (34) only decreases by the amount of diffused reflection. In this case, the spacing of the A system 20 and the B system 30 is separated only by distance L. If this distance L is suitably greater than the above-stated defect size, when the light reception optical fiber of one system (for example, the light reception optical fiber 24 of A system 20) guides light declined in strength by the influence of a defect, the light reception optical fiber (light reception optical fiber 34 of B system 30) of the system on the other side will guide the light not declined in strength (namely, intense reflected light strength from a smooth surface without a defect). Consequently, in this case, because the electrical signal Sa becomes less than (<) the electrical signal Sb, the difference value clearly becomes greater as compared with the above-mentioned normal condition (Sa=Sb).

The above principle can be applied as in “when the electrical signals Sa and Sb are outputted from the two light detectors 25 (35), the difference in values is calculated and a greater difference indicates an inspectable surface has a defect which can be discriminated”.

The reason at least two systems (the A system 20, the B system 30) are required is as follows: based on the above-stated principal explanation, when an inspectable surface does not contain a defect, the electrical signal Sa (or Sb) outputted from either of the systems constitutes a “greater value.” Subsequently, when an inspectable surface contains a defect, while either system is receiving reflected light (declined light strength only by the percentage of diffused reflection) from a defect, the electrical signal Sa (or Sb) outputted from that system constitutes a “lesser value.”

In the above principle, a judgment is possible by recognizing these “greater values” and “lesser values.” However, the surface of the metal rings 2a used in a CVT belt as an object to be inspected is in most cases delustered (dull finish) and because the degree of delustering is not standard for each product (or lot), variations occur in the “greater value” of the electrical signal Sa (or Sb) which serves as the standard for normal judging. The influence of the above-stated variations can be eliminated by configuring the optical sensor sections with “at least two systems” and taking the “difference value” between the electric signal Sa (and Sb) outputted from those systems.

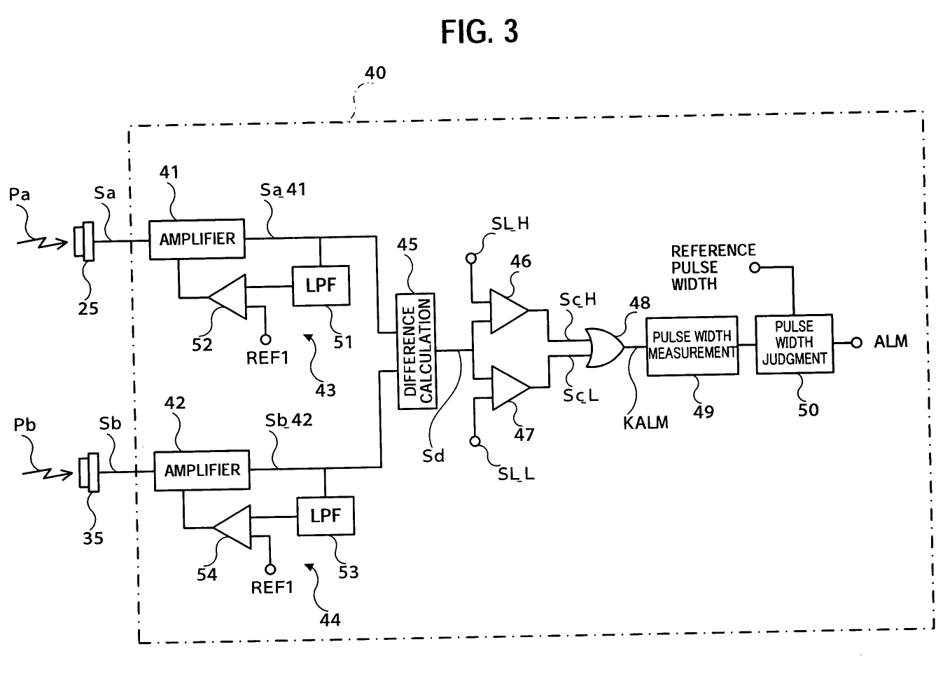

FIG. 3 is a block diagram of a judgment section 40 in the first embodiment. Referring now to this drawing, the judgment section 40 configuration includes an amplifier 41 for A system, an amplifier 42 for B system, an AGC circuit 43 for A system, an AGC circuit 44 for B system, a difference calculation section 45 (difference value calculation means), a high side threshold value judgment section 46 (first discrimination means), a low side threshold value judgment section 47 (first discrimination means), an alarm signal generation section 48, a pulse width measuring section 49 (second discrimination means, measuring means) and a pulse width judgment section 50 (second discrimination means, judging means).

The amplifier 41 for A system amplifies the electrical signal Sa which is outputted from the light detector 25 of the A system and fluctuation control of the amplification factor is performed by the output of the AGC circuit 43 for A system. The AGC circuit 43 for A system includes a low-pass filter 51 which extracts only a low-frequency component contained in the continuous current from among the output signals of the amplifier 41 for A system and a differential amplifier 52 which generates the AGC voltage of the amount corresponding to the difference between the output of the low-pass filter 51 and a predetermined reference voltage REF1. The amplifier 41 for A system amplifies the electric signal Sa by the amplification factor corresponding to this AGC voltage. The purpose of this AGC voltage is to remove low-frequency component “fluctuations” (generated in connection with “surface blurring” of the metal rings 2a) contained in the electrical signal Sa.

The amplifier 42 of B system like the above-stated amplifier 41 for the A system amplifies the electrical signal Sb outputted from the light detector 35 for the B system and fluctuation control of the amplification factor is performed by the output of the AGC circuit 44 for B system. The AGC circuit 44 for the B system includes a low-pass filter 53 which extracts only a low-frequency component contained in continuous current from among the output signals of the amplifier 42 for B system and a differential amplifier 54 which generates the AGC voltage of the amount corresponding to the difference between the output of the low-pass filter 53 and a predetermined reference voltage REF1. The amplifier 42 for B system amplifies the electrical signal Sb by the amplification factor corresponding to this AGC voltage. The purpose of this AGC voltage is the same as that above which is to remove low-frequency component “fluctuations” contained in the electrical signal Sb.

The difference calculation section 45 calculates a difference value Sd between an electrical signal Sa_41 outputted from the amplifier 41 for A system and an electrical signal Sb_42 outputted from the amplifier 42 for B system.

The high side threshold value judgment section 46 compares the difference value Sd calculated in the difference calculation section 45 with a predetermined high side threshold value SL_H and outputs a high side determination result signal Sc_H which becomes active when Sd is greater than SL_H (Sd >SL_H). The low side threshold value judgment section 47 compares the same difference value Sd with a predetermined low side threshold value SL_L and outputs a low side determination result signal Sc_L which becomes active when Sd is greater than SL_L (Sd >SL_L). In addition, the alarm signal generation section 48 outputs an alarm signal KALM indicating “provisional” defect detection on an inspectable surface when either of these two determination result signals (Sc_H, Sc_L) become active. At this point, the provisional alarm signal KALM does not distinguish between a “harmful flaw” and a “harmless flaw” explained earlier. Both of these flaw distinctions are performed by the pulse width measuring section 49 and the pulse width judgment section 50 which are the characteristic integral sections of the present invention and attached to the subsequent stage of the alarm signal generation section 48.

The pulse width measuring section 49 measures the pulse width of the provisional alarm signal KALM (This pulse width is corresponds to “the discrimination duration time of an existing defect on an inspectable surface” mentioned in the above summary of the invention.). The pulse width judgment section 50 compares the pulse width measured (hereinafter denoted as “measured pulse width”) by the pulse width measuring section 49 with a predetermined reference pulse width. When the measured pulse exceeds the predetermined reference pulse width (corresponds to “predetermined base time” mentioned in the above summary of the invention, a “harmless flaw” is judged. Conversely, when the measured pulse does not exceed the predetermined reference pulse width, a “harmful flaw” is judged. Only when the operation judges a “harmful flaw”, a “definitive” (final decision) alarm signal ALM is outputted indicating defect detection on an inspectable surface.

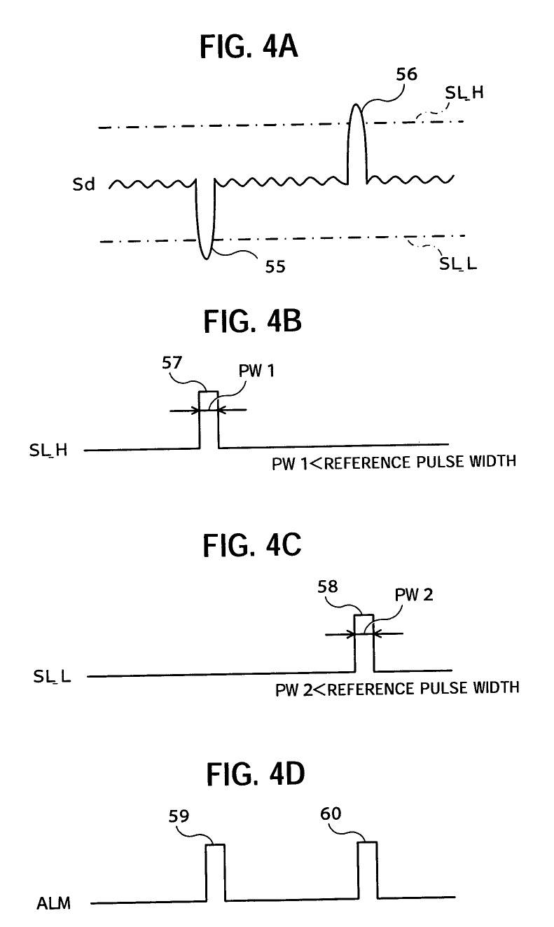

FIGS. 4A˜4D are conceptual diagrams of a harmful flaw in the first embodiment. In FIG. 4A, the difference value Sd includes peak signal waveforms 55 and 56 which correspond to harmful flaws. These signal waveforms 55 and 56 exceed the two threshold values SL_H and SL_L. For this reason, the high side determination result signal Sc_H. in FIG. 4B and the low side determination result signal Sc_L in FIG. 4C, respectively include active portions 57 and 58 of the pulse width PW1 and PW2 corresponding to the excess amount of the threshold values SL_H and SL_L of the above-mentioned signal waveforms 55 and 56. The pulse widths PW1 and PW2 become substantially smaller values because the signal waveforms 55 and 56 described above are “peak” waveforms.

At this stage, supposing that the reference pulse width is greater than PW1 (and PW2), the “reference pulse width>PW1” and the “reference pulse width>PW2” will be judged in the pulse width measuring section 49. Consequently, in this case since the operation judges the results as harmful flaws as shown in FIG. 4D, the alarm signal ALM generates output containing two active portions 59 and 60.

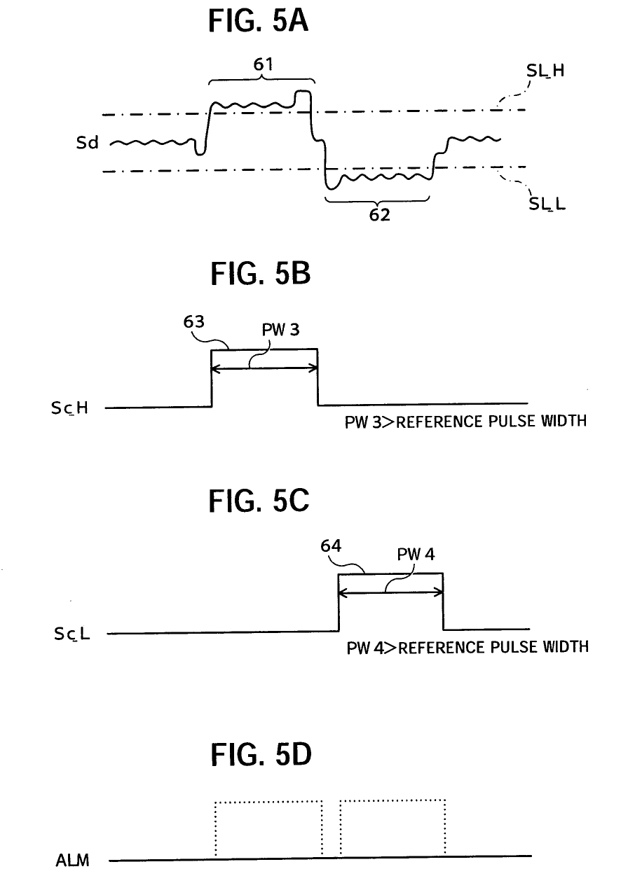

Conversely, FIGS. 5A˜5D are conceptual diagrams of a harmless flaw in the first embodiment. In FIG. 5A, the difference value Sd includes relatively broad width peak signal waveforms 61 and 62 with relatively wide width corresponding to a harmless flaw. These signal waveforms 61 and 62 exceed the two threshold values SL_H and SL_L. For this reason, the high side determination result signal Sc_H in FIG. 5B and the low side determination result signal Sc_L in FIG. 5C, respectively include active portions 63 and 64 of the pulse width PW3 and PW4 corresponding to the excess amount of the threshold values SL_H and SL_L of the above-mentioned signal waveforms 61 and 62. The pulse widths PW3 and PW4 become substantially larger values because the signal waveforms 61 and 62 described above are “relatively wide width” waveforms.

At this stage, supposing that the reference pulse width is smaller than PW3 (and PW4) , the “reference pulse width<PW3” and the “reference pulse width<PW4” will be judged in the pulse width measuring section 49. Consequently, in this case since the operation judges the results as harmful flaws as shown in FIG. 4D, the alarm signal ALM generates output containing two active portions 59 and 60. Consequently, in this case since the operation judges the results as harmless flaws as shown in FIG. 5D, the alarm signal ALM generates output of only inactive portions. As a direct result, a harmless flaw on an inspected object (metal rings 2a) will be disregarded and not eliminated as a defective part (CVT belt).

Based on the embodiment described above, only a harmful flaw will be detected as a defect and without excessive detection of a harmless flaw, for example a gloss mark, and that alarm signal ALM can be outputted. Therefore, metal rings 2a which have only a harmless flaw can be certified as passing a “Quality Approved” inspection, as well as a waste of resources can be markedly prevented and an improvement in the per unit cost of each CVT belt can be achieved.

Furthermore, the present invention is not limited to the above-stated embodiment. Within the scope of the technical concept, naturally various modifications or future development cases are included. For example, the present invention may be adapted as follows:

<Second Embodiment>

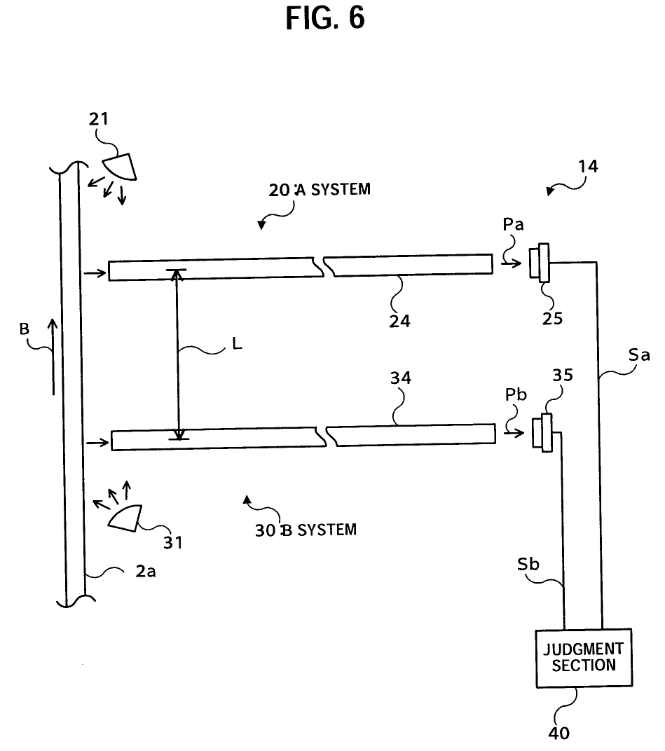

FIG. 6 is a conceptual line block diagram of an inspection section 14 in the second embodiment. Referring to this drawing, the differences with the first embodiment are that the position of the light source 21 (31) is relocated and the illuminating optical fibers 22 and 23 (32, 33) are not present.

Specifically, the second embodiment differs in that the inspectable surface (here, though regarded as the “front end face” of the metal rings 2a, this can also be the “rear end face” of the ring.) of an object (metal rings 2a) to be inspected is directly illuminated (irradiated) without passing light from the light source 21 (31) via the illuminating optical fibers 22 and 23 (32, 33). Also, another difference is that the direction of the illumination is set slanting diagonally (for example, 45 degrees, although not particularly limited to this setting) in relation to an inspectable surface.

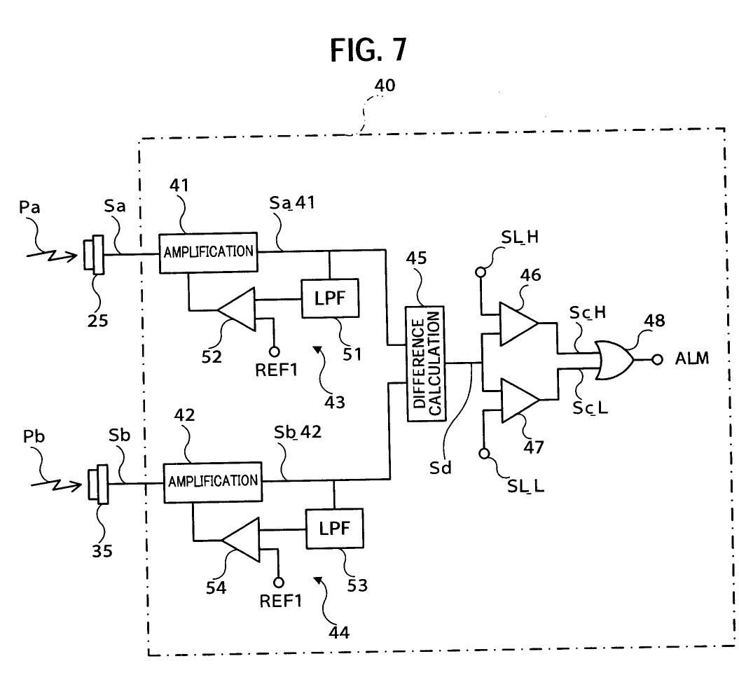

FIG. 7 is a block diagram of a judgment section 40 in the second embodiment. Referring to this drawing, the differences with the first embodiment are that the pulse width measuring section 49 and the pulse width judgment section 50 are omitted. Also, the output signal of the alarm signal generation section 48 constitutes the “definitive” (final decision) alarm signal ALM instead of the “provisional” (conditional) alarm signal KALM.

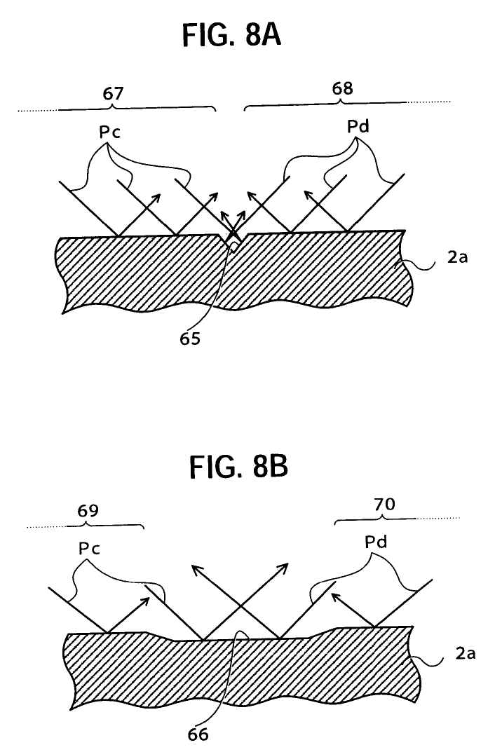

FIGS. 8A˜8B are drawings showing the reflection condition of an inspectable surface in the second embodiment. Referring to this drawing, an inspectable surface is the front end face (or rear end face) of the metal rings 2a. The harmful flaw 65 and the harmless flaw 66 are formed on this inspectable surface.

The irradiated light Pc and Pd shows the irradiated light being slanted diagonally from each light source 21 (31). The slanting irradiated light Pc and Pc is irradiated diagonally onto the normal portions 67, 68, 69, and 70 (portions without the harmful flaw 65 or the harmless flaw 66) of an inspectable surface and the harmless flaw portion 66, as well as reflected diffusely in the harmful flaw 65 portion.

When the intensities of such reflected light are compared, the reflected light of the harmful flaw 65 portion constitutes minimum intensity, followed by the reflected light of the normal portions 67, 68, 69, 70 which constitute intermediate intensity, and the reflected light of a harmless flaw 66 portion which serves as the maximum intensity. Here, diffused reflection occurs in the harmless flaw 65 portion and a considerable amount of the reflected light quantity declines. On the other hand, diffused reflection does not occur in the normal portions 67, 68, 69, 70 and the harmless flaw 66 portion. Thus, at least, the reflected light intensity exceeds that of the harmful flaw 65 portion. Moreover, in contrast with the normal portions 67, 68, 69, 70 in a lusterless (dull) state, the harmless flaw 66 portion is glossy (shiny).

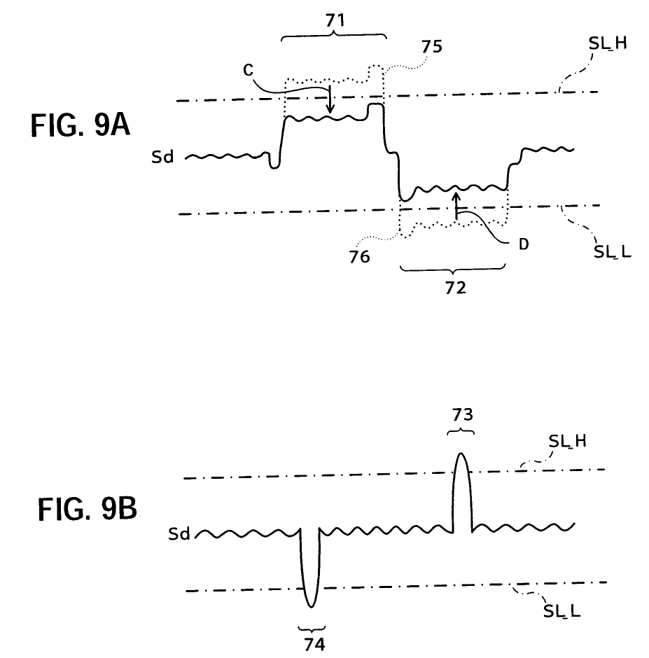

FIG. 9 is a waveform diagram of a difference value Sd which includes a “harmless flaw” and a “harmful flaw” signal in the second embodiment. As shown in FIG. 9A, the waveform portions 71 and 72 corresponding to a harmless flaw do not exceed the threshold values SL_H and SL_L. Consequently, the alarm signal ALM is not generated in this case. Meanwhile as shown in FIG. 9B, since the waveform portions 73 and 74 corresponding to a harmful flaw do exceed the threshold values SL_H and SL_L, the alarm signal ALM is generated.

Here, the reason the wave form portion 71 and 72 corresponding to a harmless flaw do not exceed the threshold values SL_H and SL_L is that the light from the light source 21 (31) is irradiated diagonally onto the inspectable surface. By irradiating diagonally, this method decreases the reflected light Pa (Pb) guided to the light detector 25 (35) via the light reception optical fiber 24 (34). The waveforms 75 and 76 shown in FIG. 9A are those acquired in the above-mentioned first embodiment. In short, this is light irradiated from above vertically onto the inspectable surface via the illuminating optical fibers 22 and 23 (32, 33) and the reflected light Pa (Pb) from the front face harmless flaw in this case is intense. Thus, the threshold values SL_H and SL_L will be exceeded. In this second embodiment, when light from the light source 21 (31) is diagonally irradiated, the waveforms 71 and 72 will become a dimension which is less than the threshold values SL_H and SL_L (refer to arrows “C” and “D” in FIG. 9A).

Consequently, even if configured like the second embodiment, a “harmless flaw” and a “harmful flaw” can be clearly distinguished. As a result, metal rings 2a which have only a harmless flaw can be certified as passing a “Quality Approved” inspection, as well as a waste of resources can be markedly prevented and an improvement in the per unit cost of each CVT belt can be achieved.

Besides, in the above-stated embodiments, although the optical sensor section is formed by two systems (the A system 20 and the B system 30), it may be configured with multiple systems exceeding two. Also, when configured with multiple systems more than two, each system may be situated on the periphery direction and width direction of the metal rings 2a (a two-dimensional array).

Furthermore, in the above-mentioned embodiments, although the reflected light from an inspectable surface is guided to the light detector 25 (35) via the light reception optical fiber 24 (34) , the use of this “optical fiber” merely indicates the best mode of the embodiment. In brief, what is necessary is just a “light guiding object” which can guide reflected light from an inspectable surface to the light detector 25 (35) with the smallest possible intensity loss. For example, if intensity loss and flexibility are disregarded or ignored, the light guiding object may simply be made out of glass or plastic.

Lastly, in each of the above-mentioned embodiments, although CVT belt 1 component parts are inspected for defects in the metal rings 2a front face or rear face, this only shows a detailed example of an object to be inspected. The object to be inspected only has to have a metal front face, namely a “metal surface”.

While the present invention has been described with reference to the preferred embodiments, it is intended that the invention be not limited by any of the details of the description therein but includes all the embodiments which fall within the scope of the appended claims.

1. A metal surface inspection device comprising:
a light source for illuminating an inspectable surface of an object to be inspected;
a first light guiding path for guiding a reflected light from said inspectable surface to a first light detector and a second light guiding path for guiding said reflected light to a second light detector;
a difference value calculation means for calculating a difference value between an electrical signal outputted from said first light detector or an electrical signal correlated to its electrical signal and an electrical signal outputted from said second light detector or an electrical signal correlated to its electrical signal; and
a first discrimination means for discriminating the presence of a defect on said inspectable surface and comparing said difference value with a predetermined threshold value;
a second discrimination means for validating the discriminated result of said first discrimination means in cases where an existing defect on said inspectable surface is discriminated by said first discrimination means and only when the discrimination duration time of the same existing defect is less than a predetermined base time.

2. The metal surface inspection device according to claim 1, wherein said second discrimination means includes:
a measuring means for measuring the time width of the portion with an existing defect in the signal outputted from said first discrimination means; and
a judging means for judging whether or not the time width measured by said measuring means exceeds a predetermined base time.

3. A metal surface inspection device comprising:
a light source for illuminating an inspectable surface of an object to be inspected;
a first light guiding path for guiding a reflected light from said inspectable surface to a first light detector and a second light guiding path for guiding said reflected light to a second light detector;
a difference value calculation means for calculating a difference value between an electrical signal outputted from said first light detector or an electrical signal correlated to its electrical signal and an electrical signal outputted from said second light detector or an electrical signal correlated to its electrical signal;
a first discrimination means for discriminating the presence of a defect on said inspectable surface and comparing said difference value with a predetermined threshold value; and
wherein light from said light source diagonally illuminates toward said inspectable surface.
